(19) United States
(12) Patent Application Publication
(10) Pub. No.: US 2007/0047823 A1
(43) Pub. Date: Mar. 1, 2007

(54) SYSTEM AND METHOD FOR STRUCTURING AND SEARCHING SETS OF SIGNALS

(75) Inventors: Harald Kirsch, Saffron Walden (GB); Dietrich Rebholz-Schuhmann, Cambridge (GB)

Correspondence Address: AKC PATENTS, 215 GROVE ST., NEWTON, MA, 02466, US

(73) Assignee: MONQ, Heidelberg, DE (US)

(21) Appl. No.: 11/553,722

(22) Filed: Oct. 27, 2006

Related U.S. Application Data
(63) Continuation of application No. 10/473,022, filed on Sep. 25, 2003, now abandoned.

(30) Foreign Application Priority Data
Mar. 26, 2001 (EP) 01107524.9
Mar. 26, 2002 (WO) WO 02082314

(51) Int. Cl. G06K 9/62

(52) U.S. Cl. 382/224; 382/305

(57) ABSTRACT

A method of searching and identifying a signal includes the steps of providing a signal having one or more signal units and identifying at least one of the signal units by a predetermined pattern having a first order. Next, comparing a group of the one or more signal units comprising the at least one signal unit, to one or more predetermined patterns having an order higher than the first order, and if a match is found, modifying the signal by replacing the group of the one or more signal units by a higher order signal unit. Finally, identifying the higher order signal unit by a higher order pattern, wherein the higher order pattern comprises information identifying the group of one or more signal units. The predetermined patterns are ordered according to a hierarchy, wherein a higher order pattern comprises at least one lower order pattern. The signal may be electronic data, transient signals, digital signals, analogue signals, text, spectra, gene sequences or genetic data.

### CROSS REFERENCE TO RELATED CO-PENDING APPLICATIONS

This application is a continuation and claims the priority benefit of U.S. application Ser. No. 10/473,022, filed on Sep. 25, 2003 and entitled “METHOD AND APPARATUS FOR STRUCTURING AND SEARCHING SETS OF SIGNALS” the contents of which are expressly incorporated herein by reference.

### FIELD OF THE INVENTION

The invention relates to a method of searching and extracting information from a set of signals by structuring them according to predetermined patterns and by introducing additional information into the signal or replacing part of the signal. In particular, the invention relates to a method of structuring text data, genetic data and spectral data.

### BACKGROUND OF THE INVENTION

Looking for a certain word pattern in a large number of text data is a well known problem. It usually results in large number of hits containing only a small percentage of information relevant to the query. Restricting the search to simultaneous occurrence of certain words within a certain distance to each other may help in some instances. However, it is still far from satisfactory, because this criterion only relates to the order of the words in a text and does not take into account their relation or the structure of the text. There is still the problem of getting a high number of non-relevant results, combined with the risk of missing relevant information due to restrictive search criteria.

Another problem is that in many instances information available in databases is either not structured or not structured properly. This relates especially to information from databases for experimental data, such as, gene sequences or atomic spectra. For these two examples, information is usually available that virtually forms a fingerprint of an organism or a substance. However, this information can only be exploited by a detailed analysis, which may require both a high level of skill and manpower. Although such analysis is carried out by specialists using the respective databases, the result is either not communicated to other people or communicated through different channels. Thus, the inherent information cannot be extracted.

Prior art methods for transforming a data set include the well known parsing facilities used in compilers and text filters. However, the parsing technique assumes that a structure already exists in the data and decompression and expansion of the data will reveal the hidden structure. In the case of a compiler, information that is expressed in a compressed manner in a high level programming language is expanded to make the program executable for the computer. Functional or structural relations are not added to the data. Text filters are used for extracting certain information out of a data set. These prior art methods basically correspond to the search engines mentioned above and do not add structural information to the input data. Parsing and text filters are applicable only to text files and cannot be used for non-text files such as digital signal, analogue signal, spectra, gene sequences or genetic data. A prior art method based on parsing is described by Saldahna et al in U.S. Pat. No. 6,714,939. This prior art method is based on parsing a text file using the grammar of the natural language to construct parse trees. The parse trees are mapped onto instance trees, which are then executed by an application in order to generate structured data. However, as we mentioned above, the Saldhana et al method cannot handle non-text files or text files that do not obey a natural language grammar, i.e., a computer language or a sign based language. Accordingly, there is a need for a method for structuring data so that they can be searched easily, and in particular a method that can structure non-text based data and text-based data that do not necessarily obey a natural language grammar.

### SUMMARY OF THE INVENTION

In general, in one aspect, the invention features a method of searching and identifying a signal. The method includes the steps of providing a signal having one or more signal units and identifying at least one of the signal units by a predetermined pattern having a first order. Next, comparing a group of the one or more signal units comprising the at least one signal unit, to one or more predetermined patterns having an order higher than the first order, and if a match is found, modifying the signal by replacing the group of the one or more signal units by a higher order signal unit. Finally, identifying the higher order signal unit by a higher order pattern, wherein the higher order pattern comprises information identifying the group of one or more signal units. The predetermined patterns are ordered according to a hierarchy, wherein a higher order pattern comprises at least one lower order pattern. The signal may be electronic data, transient signals, digital signals, analogue signals, text that does not obey a natural language grammar, spectra, gene sequences or genetic data.

Implementations of this aspect of the invention may include one or more of the following features. The steps of comparing, matching and modifying are repeated until all of the one or more signal units are matched and replaced by higher order signal units. The higher order signal unit comprises information distinguishing it from other signal units. The predetermined patterns may be stored in a database. The method may further include creating a new signal unit comprising the group of the one or more signal units and the new signal unit is identified by the higher order pattern and comprises information indicating the higher order pattern. The method may further include at least partly replacing the one or more signal units by the new signal unit. The method may further include modifying the signal such that at least one signal unit can be searched for and extracted. The method may further include inserting searchable information in the new signal unit. If no match is found for the group of signal units, the method further includes, selecting a new group of signal units and comparing the new group to the predetermined patterns. The steps of selecting a new group of signal units and comparing the new group to the predetermined patterns are repeated until no further matches to the predetermined patterns are found. The steps of selecting, comparing and modifying are repeated, until no match is found or the higher order signal unit comprises the entire modified signal The method may further include extracting at least one signal unit from the signal. The method may further include tagging the one or more signal units. The signal may also be text that obeys natural language grammar.

In general, in another aspect, the invention features an apparatus for searching and identifying a signal that includes one or more signal units. The apparatus includes means for identifying at least one of the signal units with a predetermined pattern having a first order; means for comparing a group of the one or more signal units, comprising the at least one signal unit, to one or more predetermined patterns having an order higher than the first order; and means for modifying the signal if a match is found, by replacing the group of the one or more signal units by a higher order signal unit, wherein the higher order signal unit is identified by a higher order pattern than the first order and comprises information identifying the group of one or more signal units. The predetermined patterns are ordered according to a hierarchy wherein a higher order pattern comprises at least one lower order pattern and the signal may be electronic data, transient signals, digital signals, analogue signals, text, spectra, gene sequences or genetic data.

Among the advantages of this invention may be one or more of the following. The method is applicable to data that may be non-text data, spectra, genetic sequences, genetic data, analogue or digital signals, transient signals, or electronic data. The method is also applicable to text-based data that do not necessarily obey natural language grammar. The method furthermore enriches the data with added information that increases the benefit in terms of understanding and linking to other electronic data resources.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is an overview diagram of the method for structuring signals according to the present invention;

FIG. 2 is an example of structuring a set of text signals according to this invention;

FIG. 3 is a continuation of the example of FIG. 2;

FIG. 4 is an example of structuring a set of spectral data according to this invention; and

FIG. 5 is an example of structuring a gene sequence according to this invention.

### DETAILED DESCRIPTION OF THE INVENTION

The object of this invention is to provide a method for structuring a set of signals in a way that searches can be carried out more efficiently and facts can be identified and structured. This object is accomplished by a method of automatically structuring a set of signals according to predetermined patterns by a computer. The patterns are sorted into a hierarchical order so that a pattern of a higher order comprises at least one pattern of a lower order. The method includes the steps of:
providing a set of signals comprising at least one unit of signals matching a signal pattern, the unit comprising information identifying the signals comprised in the unit, e.g. data marking the start or end of the unit or indicating the location of elements of the unit,
comparing a group of signals out of the set of signals, comprising at least one of the units, to one or more predetermined patterns of a higher order than the order of a pattern matching one of the units, especially of an order higher than the highest order of the units contained in the group, in particular the next higher order, by the processing apparatus,
if a match is found, modifying the set of signals by the processing apparatus, the step of modifying the set comprising the step of replacing the group of signals matching the pattern by a higher order unit corresponding to the group of signals matching the higher order pattern, the unit having an order corresponding to the order of the higher order pattern and comprising information identifying the signals comprised in the unit.

The signals may be electronic data in a data format provided for a data processing system. In other examples, the signals may be other physical entities representing information and in particular they may be transient signals, digital or analogue signals, without necessarily comprising a specific format or shape. These signals may represent, for example, gene or protein sequences, measurement data, such as atomic spectra, words in an artificial language, such as a programming language, or words in a natural language, just to mention a few possible applications.

The set of signals can be a sequence in time or a sequence according to an imposed order, such as a certain order of storage spaces. It can also, for example, comprise separate sequences of data taken from a larger entity.

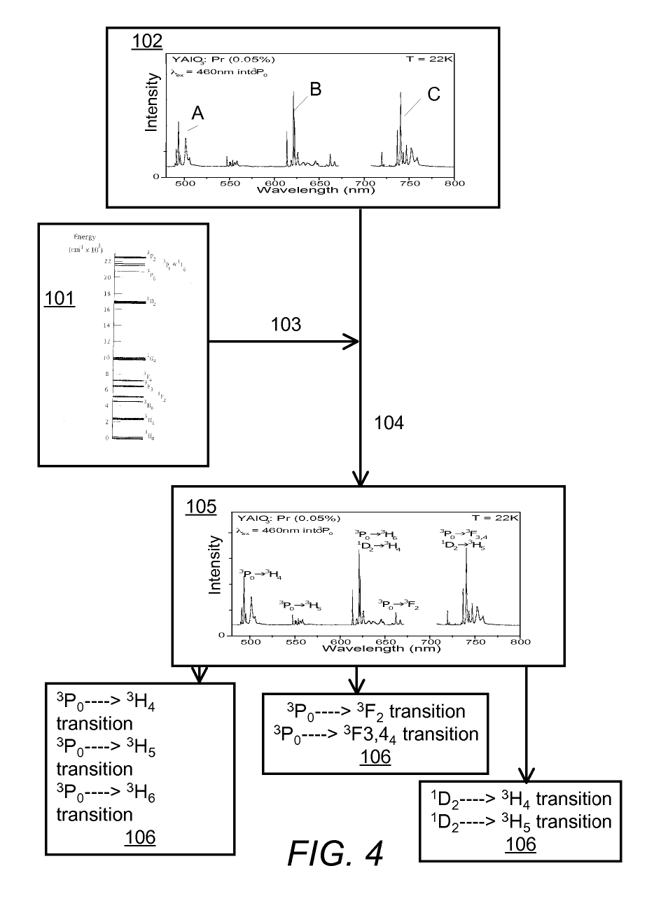

In one specific example, the group of signals that is compared to a pattern includes only one signal or signal element. Likewise, the group may be a coherent sequence of signals. In the example of FIG. 4, the signals represent a spectrum and the peaks A, B, C, are related to a certain element, i.e., Praseodymium (Pr). These peaks may be used as the pattern that is compare to the signal for identification purposes. The group of signals that is chosen for comparison may comprise parts of the spectrum that are separated from each other.

The chosen pattern may be a pattern that is not defined by syntactic and/or semantic rules of a natural language.

The term “unit” mentioned above is understood to mean an element of the structure that is imposed on the set of signals. A “unit” is distinguished as a group from other signals in the set of signals by appropriate tags. It does not necessarily imply that the unit itself has a certain internal structure, although this may be the case, especially if the unit is a unit of a higher order and comprises units of lower order.

The step of modifying the group of signals includes adding additional signals into the existing set of signals, e.g. signals marking the start and the end of the unit. The matched group of signals is entirely or partly replaced by a group comprising the signals forming the initial group matched by the pattern plus additional signals inserted into the group or part thereof. In other words the matched group of signals or part thereof is enhanced by additional information. The step may also include the replacement of part or all of the signals of the group by other signals representing the higher order unit. For example, a certain sequence of data having a specific relation between its elements may be replaced by the name of a function with the elements as its arguments.

The invention also provides that one or more units matching a pattern comprise information on the pattern matched.

The invention may also provide that one or more signals marking the start and/or end of a sequence of the unit are inserted in the initial group matching the pattern. If the group includes one single coherent sequence of signals, the start and/or end of the group is marked thereby. If the group includes a plurality of partial sequences, information pointing to the beginning of the next partial sequence may be provided at the end of each partial sequence. Thus, although it is preferred that the unit includes a sequence of signals between a well defined starting point and a well defined end point, the signals representing the unit need not necessarily be sequential to each other, as long as it is clear which signals belong to the unit and which do not.

The invention may comprise the step of creating additional signals indicating properties of the matching higher order pattern and assigning these additional signals in a retrievable manner to the higher order unit. The properties of the pattern may especially be properties distinguishing the pattern from other patterns, but may also comprise additional information which may, for example, come in useful in a further search, e.g. comments or explanatory notes by a user, a reference or link to another data set or another unit and the like.

According to the invention, information distinguishing the pattern from other patterns may, for example, be a property, such as being a noun or any other term, if the group of signals matching the pattern represents a word, a physical property, if the group of signals indicates a substance, a certain functionality, if the signals represent a nucleic acid sequence. As another example, the distinguishing information may be a name or another identifier for the group of signals. For a sequence or a spectrum, the information may be a marker marking those parts related to a certain functionality or a certain element.

The additional information may be introduced into the modified set of signals, as will be explained in more detail. It may however also be contained in a separate set of signals, e.g. a separate set of data, more specifically a separate data file, wherein the entries are correlated with the structural units in a unique and unambiguous manner. Such correlation may be introduced by specific reference data, e.g. links. It may, however, also be inherently contained in the additional separate data, e.g. by structuring these additional separate data in the same or similar manner as the modified set of data.

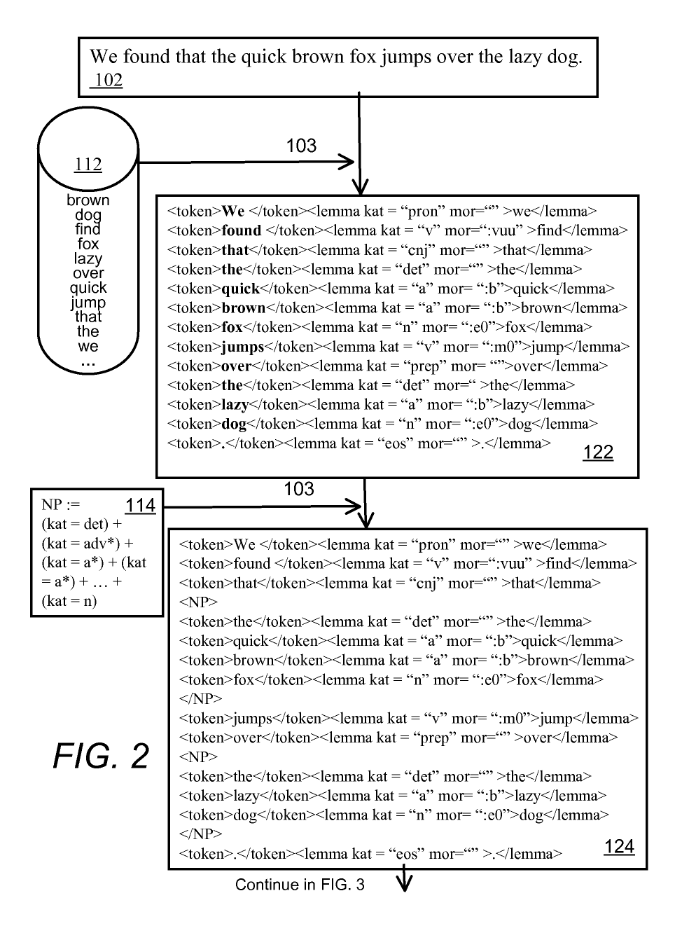

If additional information on the patterns is provided, one implementation of structuring a sequence of data may, for example, provide that the additional information is stored in a separate reference file and that the first entry in the reference file relates to the pattern of which the data marking the start of the related unit occurs first in the sequence of modified data. In another implementation the unit may comprise data distinguishable from the data of the original data set comprising a reference to a certain entry in the reference file. For example, data referring to the reference file can be distinguishable by way of a certain initial sequence of data, such as e.g. ref or the like. In a still further embodiment the data may be contained in the modified sequence of data and identified by means of tags marking the start and the end of the additional data, e.g. by “<lemma>” marking the start of the additional information and “</lemma>” marking the end of the additional information, as shown in FIG. 2.

It should be noted that the additional information may be provided not only in the higher order units introduced by the above-mentioned process, but may also be present in or provided for the units contained in the set of signals initially provided.

The processing apparatus may be a computer, or any other hardware for processing signals, e.g. a computing circuit. In fact any apparatus, which represents a Turing machine, can be used to perform the method according to this invention. Any of these apparatus can be used in a cascaded fashion or in a pipeline one after the other.

The set of signals provided for comparison is not necessarily restricted to sets having units of lowest order. Rather, the data set used for comparison to patterns may comprise units of any order lower than the highest order. Especially, it may be the result of a previous structuring step replacing a group of signals by a unit of an order lower than the order of the patterns for which a match is sought.

Matching a group of signals to a pattern does not necessarily mean a 100% identity. Especially in case of analog data, but also with digital data derived from experiments or from measurements in the real world, there will frequently only be a certain degree of similarity in case of a match. Related matching criteria are well known in the art, e.g. that a suitable metric defined for the signals (e.g. the sum or integral over the difference of subsequent data) yields a distance of the group of signals to the pattern that is less than a predetermined value.

The invention may provide that in case of a non-perfect match of a selected group of signals to a higher order pattern a consistency check is performed as to whether the units of lower order, which are contained in the group of signals matched to the pattern, are consistent with the definition of the higher order pattern and/or if the quality of the match can be improved, if a different assignment of the signals contained in the lower order units to one or more patterns is chosen. For non-consistent units the initial data are restored, i.e. the data identifying the unit and indicating properties thereof are removed, and the process of comparing groups of signals to patterns is repeated, but restricted to the group of signals matching the higher order pattern.

The invention may provide that the step of providing a set of signals comprises:
providing a set of signals,
comparing a group of signals forming part of the set to one or more predetermined patterns,
if a match is found, modifying or transforming the set of signals, the step of modifying the set comprising the step of replacing the group of signals matching the pattern by a unit of signals, the unit having an order corresponding to the order of the matching pattern and comprising information on the signals comprised in the unit.

Again, additional information may be created and stored related to the unit created in the modifying step, which may be contained in the unit, but which may also be contained in a separate set of signals, e.g. a separate data file. This additional information may especially be information distinguishing the pattern matched to the group of signals from other patterns.

Thus, the invention may provide the iteration of the steps of comparing signals to patterns and modifying the signals in case of a match. In one embodiment of the invention, the method starts from a set, e.g. a sequence, of basic data without any structural information and builds up a structure in the data by the comparing and matching steps. At any level, the steps for comparing, matching and modifying parts of the data set are essentially the same, unless indicated otherwise subsequently.

The step of providing a set of signals may also include the definition and identification of input signals, especially a sequence of input signals.

The invention may provide that at least one of the patterns to be matched is stored in a database.

Alternatively or in addition the invention may provide that one or more patterns are inherently implemented in the processing means. For example, a program code or a hardwired solution for comparing the signals to a pattern may comprise all necessary steps to verify whether a certain group of signals corresponds to a certain pattern without specifying the pattern in a coherent manner, e.g. without retrieving the definition of the pattern.

The invention may provide that all relevant patterns are stored in a database, that all patterns are implemented in the processing means, especially program code thereof, or that part of the patterns is stored in a database and part is implemented in the processing means.

The invention may also provide that information regarding the patterns is stored in more than one database.

The invention may provide that at one or more levels the step of modifying the set of signals comprises creating a unit of signals, which comprises the group of signals matching the pattern as well as additional information indicating the pattern matching the unit.

Such additional information may, for example, be added in the form of attributes or tags in a predetermined data format.

The invention may provide that at one or more levels the step of modifying the set of signals comprises at least partly replacing the original group of signals by new signals representing information related to the pattern.

For example, the group of signals matching the pattern may be replaced by signals representing the name of the pattern or otherwise identifying the pattern. As another example, the invention may provide that if a match involving units of a lower level is made, the modifying step replaces the group of signals by the designation of a function having lower order units as arguments.

The invention may provide that at one or more levels, the step of creating a unit comprises the modification of the set of signals such that at least one pattern, especially a pattern of an order higher than the lowest order, can be searched for and/or extracted.

The invention may provide that at one or more levels, the step of creating a unit comprises inserting searchable information, especially searchable information identifying the pattern.

The information may e.g. be an identifying group of signals indicating the type of pattern, but may also be a plurality of signals indicating various properties of the pattern, which, taken together, allow for the identification of the pattern.

The invention may provide repeating the steps of comparing a group of signals that have not yet been assigned to a unit at the respective level to one or more patterns and creating a unit in case of a match for those signals.

The invention may provide that if no match is found for a selected group of signals, a new group of signals is selected and compared to the predetermined patterns.

The invention may provide that a group for which no match was found is expanded to comprise additional signals to those contained in the group previously. The invention may provide that signals for which no (expanded) group matching one of the patterns can be found are left unassigned to a unit.

The invention may provide that the steps of selecting a group of signals and comparing it to predetermined patterns are repeated until no further matches to patterns are found at a certain level.

The invention may provide that the steps of selecting, comparing and modifying are repeated at one or more subsequent higher levels, until a level is reached where no match is found or the unit matched to a pattern comprises the entire modified set of signals of the previous level.

According to the first alternative of this embodiment, the structuring process results in a plurality of hierarchical structures, each for a part of the initial set of signals, as there is no common unit on the highest level embracing all information. In the second instance there is a classic hierarchy with one unit at the top and further units depending from it.

The invention may provide extracting at least one unit from the set of signals.

Usually this extracting step comprises a search for identifying information in the modified set of data, after the structuring of the data or the structuring up to a certain level has been completed. The invention may also provide that the unit is extracted after a match to a predetermined pattern has been found during the comparing step.

The extracted unit or units may be stored separately from the initial set of signals, e.g. in a database or a file. It may also be displayed on a screen or printed out for display.

The invention also provides an apparatus for automatically structuring a set of signals according to predetermined patterns, the patterns forming a hierarchy, wherein a pattern of a higher order comprises at least one pattern of a lower order, the apparatus performing the following steps when provided with a set of signals comprising at least one unit of signals corresponding to a pattern, the unit comprising information identifying the signals comprised therein:
comparing a group of signals out of the set of signals, comprising at least one of the units, to one or more predetermined patterns of a higher order than the order of a pattern matching one of the units, especially an order higher than the highest order of one of the units contained in the group, in particular the next higher order,
if a match is found, modifying the set of signals, the step of modifying the set comprising the step of replacing the group of signals matching the pattern by a higher order unit created from the group of signals matching the higher order pattern, the unit having an order corresponding to the order of the higher order pattern and comprising information on the signals comprised in the unit.
The unit may also comprise information distinguishing this higher order pattern from other patterns.

The steps performed by the apparatus may especially be steps of any embodiment of a method according to the invention, especially one of the embodiments outlined above.

The apparatus according to the invention may perform the above-mentioned steps of comparing and modifying if provided with any sequence of signals, especially a sequence containing a unit of signals representing a match of a first order pattern and/or a higher order pattern, but also when provided with a set of signals comprising no unit as described above.

The invention also provides a data set, obtainable by a method according to a method of automatically structuring a set of signals as set out above, especially a data set of this kind expressed in a physical medium.

Such medium may be a storage medium, but also an electronic signal used for transmitting information.

The invention may provide that the data set is expressed in a format allowing for the search for one or more patterns corresponding to units in the data set.

The invention also provides a method of searching for patterns in a data set, especially a sequence of data, comprising the following steps:
providing a data set obtainable by a method as set out above, the data set comprising searchable information assigned to one or more of the units,
searching for the searchable information.

The invention may provide that the data set is provided with information limited to that of one or more selected searchable units and does not comprise the full information of the initial set of signals. According to this embodiment, part of the initial information was discarded and one or more units were extracted, e.g. to a database or a file.

The invention may, however, also provide that the information in the data set searched is the same as in the initial data set prior to applying the method according to the invention, in which case this information is, however, enhanced by structural information about the patterns present in the data set. Means for extracting one or more units that have been found in a search may, however, be provided.

The invention also provides an apparatus for performing a method of searching for patterns in a data set as set out above.

The invention may especially provide that this apparatus is also able to perform a method of automatically structuring a set of signals, especially a sequence of signals, as set out previously.

Unlike previous parsing techniques, the invention does not map the data onto a new data set having an entirely different structure, e.g. in that a certain storage space is reserved for each structural element, but basically keeps the original sequence of data, to which certain additional data are added, which are distinguished from the original data. Thus, it is possible to restore the original sequence of data simply by ignoring the additional data added in the process and, given the case, expanding again some functional definitions introduced in the process. It is also possible to use or show only selected ones of the additional data and disregard others in the communication with a user. Thus, the basic structure of the data, e.g. the sequential structure, is maintained.

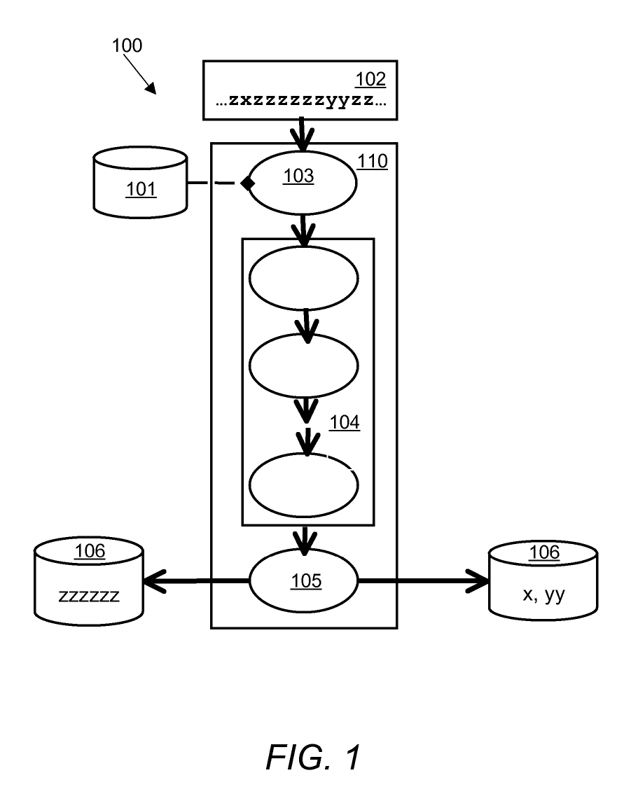

Referring to FIG. 1, information contained in a set of data 102 is marked or extracted from it by determining whether parts of these data, obey predetermined rules. In one example data 102 is a sequence of data, and partial sequences of these data that obey predetermined rules are extracted.

According to the invention it may be provided that the steps of comparing with a pattern and replacing the matching part involves the identification of a pattern by looking up the pattern or a representative part thereof (103), shown in FIG. 1, e.g. in a reference file or data base 101, shown in FIG. 1. This especially applies to a sequence or a partial sequence of data, which may especially represent a sequence in the biological sense. After identification of the pattern, the sequence may be changed, e.g. by insertion of tags, markers, links or the like, to form a unit comprising the information of the original signals together with additional information (104), shown in FIG. 1. For example, the group of signals matching the pattern may be replaced by a unit 105, which describes the information found, and which includes the signals matched 106, or parts of them or a representation of the pattern or of parts thereof. In one embodiment the unit formed thereby forms a new sequence where the additional information was inserted as sequential data. The additional information may e.g. be the class or standard form. The unit may also form a combination of one or more sequences in a group, the additional information indicating the sequences that are contained in this group and form part of the unit. The set of signals resulting from the replacement of matching parts by appropriate units can be the input to another step of comparing with a pattern and replacing the matching part where the matching part in particular may contain units introduced in a previous step. Units of higher order are formed thereby, thereby introducing a hierarchical structure in the sequence. The iteration of the step of comparing with a pattern and replacing the matching part forms additional levels in the hierarchy so that there are different hierarchical depths, including a depth zero which comprises signals which were not covered by a match in any step.

As a result of this procedure one obtains one or more hierarchical trees. As the method of the invention works from bottom up, the result may especially be a plurality of trees. This is advantageous in several respects. In many cases, a full hierarchical structure may not even exist. In other cases, errors in the initial data can make it impossible to retrieve the full hierarchical tree. In both cases a system trying to establish a single hierarchical structure for the whole data set will stall. The method of the invention does not use a predetermined hierarchical structure to be matched to the data presented to the processing apparatus, but only matches patterns at a given level in one iteration. Thus it is not necessary to define an entire hierarchy to be matched, but only to define patterns and, given the case, the relation of individual higher order patterns to lower order patterns. The method of the invention is thereby independent to create hierarchical patterns that have not been defined before or accept definitions of patterns that do not fit into known schemes. It may also provide that different hierarchies are defined simultaneously in the same data set, e.g. by labelling patterns and related units by a label for patterns related to each other and performing the matching process for certain patterns related to each other irrespective of previous matches or units established. As, according to one embodiment, the invention merely identifies patterns by adding additional signals or data without deleting the original signals or data, even overlapping patterns, which share common signals or data, may be identified and embodied in the set of signals. The method according to the invention is flexible and allows both for an inherently incomplete hierarchy as well as for errors, in both cases returning partial hierarchies showing the relationship between the data items, as far as they can be established.

The hierarchical structure also makes it possible to extract parts of the information 106 by extracting a node of the tree with all dependent nodes at lower levels, thereby preserving all information relevant to this node (which may be the item searched for) by virtue of the information contained in the lower levels (105), shown in FIG. 1.

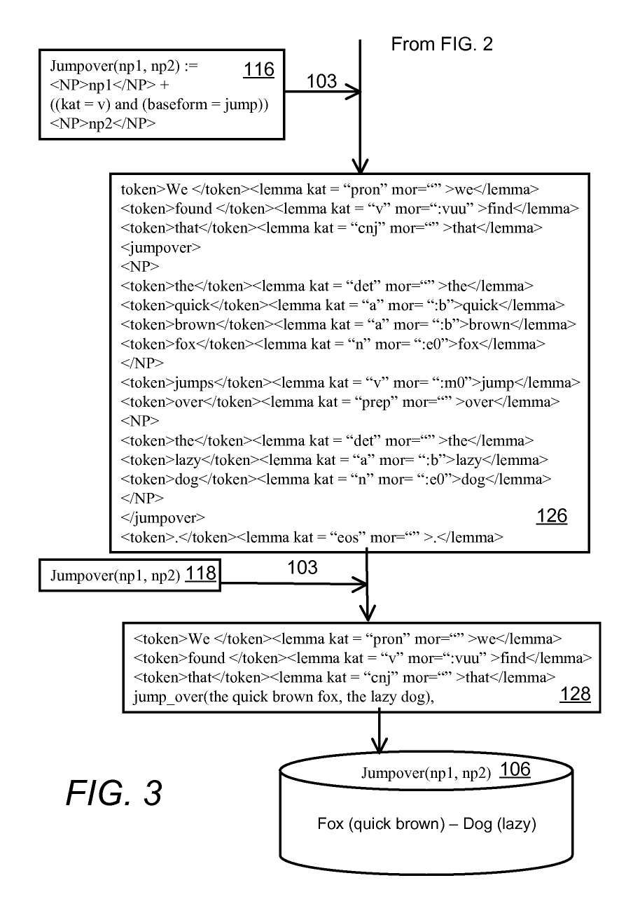

The basic principles of the invention are illustrated by a simple example, shown in FIG. 2 and FIG. 3, which is non-limitative and merely intended for the purpose of illustration. Given an input sequence of signals of the form:

“We found that the quick brown fox jumps over the lazy dog.” (102)

a lexical analysis, using a dictionary (112) and information on English grammar will provide additional information about the grammatical nature of the various elements separated by blanks in the original sequence (i.e. the words), e.g. as to the type of the word and its state of lexicon. The result is as follows (122)

<token>We </token><lemma kat=“pron” mor=””>we</lemma>
<token>found</token><lemma kat=“v” mor=”:vuu”>find</lemma>
<token>that</token><lemma kat=“cnj” mor=””>that</lemma>
<token>the</token><lemma kat=“det” mor=““>the</lemma>
<token>quick</token><lemma kat=“a” mor=“:b”>quick</lemma>
<token>brown</token><lemma kat=“a” mor=“:b”>brown</lemma>
<token>fox</token><lemma kat=“n” mor=“:e0”>fox</lemma>
<token>jumps</token><lemma kat=“v” mor=“:m0”>jump</lemma>
<token>over</token><lemma kat=“prep” mor=““>over</lemma>
<token>the</token><lemma kat=“det” mor=”>the</lemma>
<token>lazy</token><lemma kat=“a” mor=“:b”>lazy</lemma>
<token>dog</token><lemma kat=“n” mor=“:e0”>dog</lemma>
<token>.</token><lemma kat=“eos” mor=““>.</lemma>

This sequence of data is a unit of the first order in the sense mentioned above. It comprises the initial information plus grammatical information related to the words used.

The next step for establishing units of higher order is to analyse the construction of the sentence. A grammatical database or a grammar checker (114) may provide a rule that if a determiner and an adjective precede a noun, these form a syntactical unit (det, adj, noun). Accordingly the system puts in additional information 103 indicating these groups, e.g. as follows (124):

<token>We </token><lemma kat=“pron” mor=““>we</lemma>
<token>found</token><lemma kat=“v” mor=“:vuu”>find</lemma>
<token>that</token><lemma kat=“cnj” mor=”>that</lemma>
<NP>
<token>the</token><lemma kat=“det” mor=““>the</lemma>
<token>quick</token><lemma kat=“a” mor=“:b”>quick</lemma>
<token>brown</token><lemma kat=“a” mor=“:b”>brown</lemma>
<token>fox</token><lemma kat=“n” mor=“:e0”>fox</lemma>
</NP>
<token>jumps</token><lemma kat=“v” mor=“:m0”>jump</lemma>
<token>over</token><lemma kat=“prep” mor=““>over</lemma>
<NP>
<token>the</token><lemma kat=“det” mor=““>the</lemma>
<token>lazy</token><lemma kat=“a” mor=“:b”>lazy</lemma>
<token>dog</token><lemma kat=“n” mor=“:e0”>dog</lemma>
</NP>
<token>.</token><lemma kat=“eos” mor=““>.</lemma>

thereby introducing two units (NP-tags) at the second level, namely

<NP>
<token>the</token><lemma kat=“det” mor=”>the</lemma>
<token>quick</token><lemma kat=“a” mor=“:b”>quick</lemma>
<token>brown</token><lemma kat=“a” mor=“:b”>brown</lemma>
<token>fox</token><lemma kat=“n” mor=“:e0”>fox</lemma>
</NP>

and

<NP>
<token>the</token><lemma kat=“det” mor=““>the</lemma>
<token>lazy</token><lemma kat=“a” mor=“:b”>lazy</lemma>
<token>dog</token><lemma kat=“n” mor=“:e0”>dog</lemma>
</NP>,

both being marked by markers for the start and the end of the sequence, <NP> and </NP>.

In the next iteration the system applies rules 103 as to the relation of a verb (jumpover) (116) regarding to its subject and object, resulting in (126)

<token>We </token><lemma kat=“pron” mor=““>we</lemma>
<token>found </token><lemma kat=“v” mor=“:vuu”>find</lemma>
<token>that</token><lemma kat=“cnj” mor=““>that</lemma>
<jumpover>
<NP>
<token>the</token><lemma kat=“det” mor=““>the</lemma>
<token>quick</token><lemma kat=“a” mor=“:b”>quick</lemma>
<token>brown</token><lemma kat=“a” mor=“:b”>brown</lemma>
<token>fox</token><lemma kat=“n” mor=“:e0”>fox</lemma>
</NP>
<token>jumps</token><lemma kat=“v” mor=“:m0”>jump</lemma>
<token>over</token><lemma kat=“prep” mor=““>over</lemma>
<NP>
<token>the</token><lemma kat=“det” mor=““>the</lemma>
<token>lazy</token><lemma kat=“a” mor=“:b”>lazy</lemma>
<token>dog</token><lemma kat=“n” mor=“:e0”>dog</lemma>
</NP>
</jumpover>
<token>.</token><lemma kat=“eos” mor=““>.</lemma>,

Again, additional data were added in the form of a marker for the start and the end, namely <jumpover> and </jumpover>. It should be noted that additionally identifying information was introduced by the specific name “jumpover”, thus making it possible to search for the action jumpover, presuming the question at issue is what jumping actions can be found.

Depending on the purpose of the task at hand and presuming, sticking to the example, that the interest is more in the jumping as in the properties of the one jumping and the one being jumped over, one may compress the information by introducing a function jump_over (118), resulting in (128)

<token>We </token><lemma kat=“pron” mor=““>we</lemma>
<token>found </token><lemma kat=“v” mor=“:vuu”>find</lemma>
<token>that</token><lemma kat=“cnj” mor=““>that</lemma>

jump_over(the quick brown fox, the lazy dog),
thereby giving up some information that was retrieved earlier on. Thus, the group of data starting from <jumpover> and ending with </jumpover> is removed and replaced by a new group of data derived from it. This illustrates the case that the modification of the data set is not effected by introducing additional data, but by replacing certain data by new data. Note, however, that beginning and end of the unit “jump over” is inherently specified by the syntax, e.g. by the rule that a letter immediately following “>” is considered as the beginning of a function and “)” marks the end of a function.

Depending on the requirements one may keep the data in the form indicated above and introduce a search function covering <jumpover> or jump_over, thereby keeping all initial information.

Alternatively (if one does not care who found out who or what was jumping), the function jump_over may be extracted and transferred to another file or another database 106 allowing for a search for jumping actions, simultaneously discarding the following data

<token>We </token><lemma kat=“pron” mor=”>we</lemma>
<token>found </token><lemma kat=“v” mor=“:vuu”>find</lemma>
<token>that</token><lemma kat=“cnj” mor=““>that</lemma>.

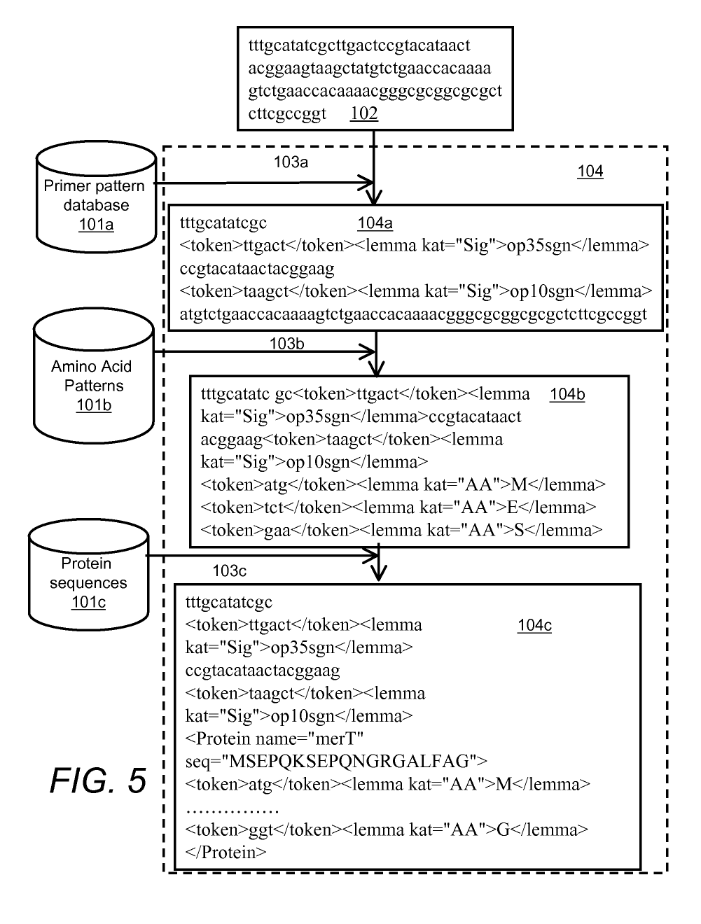

As another example, the application of the invention to biological, especially genetic data will be explained, with reference to FIG. 5.

Biomolecules consist of sequences of elements, like bases or amino acids. These sequences of single elements can be represented by letters. Thus, the data to be processed and structured will consist of one or more sequences of letters.

Biomolecules have an internal structure comprising so-called domains, the structure embodying the functionality of the biomolecule. Such domains are, for example, exons, introns, coding sequences and GPC islands in the gene sequence, and alpha-helices, beta-strands, peptides, biased regions and others in the protein. Especially, a combination of three base pairs can represent a triplet encoding one amino acid. Whether a sequence of three base pairs actually encode an amino acid, depends on the region where the triplet is in. Some regions which do not follow this principle may encode a function, e.g. a promotor. A promotor is a characteristic sequence steering a protein which starts to read the DNA.

If a coding region encodes amino acids with base triplets, the entirety of triplets represents a corresponding amino acid sequence.

There are a variety of techniques of identifying such functional domains, e.g. by pattern matching, by software algorithms like BLAST, or by recognition by a scientist.

A possible application of the invention may provide that in a first step entities of three base pairs encoding an amino acid are identified. Each of these triplets is distinguished from the rest of the sequence by introducing a tag marking the beginning of the triplet and a tag marking the end of the triplet. Additional information indicating the amino acid may be added, e.g. by data immediately following the start tag or immediately preceding the end tag and provided with a further tag at the end or beginning thereof, respectively, in order to distinguish it from the data representing the triplet.

On this level an identification of patterns other than nucleotide triplets may also be performed.

In a subsequent iteration, regions comprising triplets encoding amino acids may be identified and regions comprising other domains may be identified and both marked by tags indicating the beginning and the end of such regions. For example, units representing promotors, exons, introns etc., and related units may be created this way. Again, additional information about the nature of this region, if known, is added.

At this level, it may occur that triplets initially identified as encoding an amino acid are found to lie in a non-encoding region. In this case, the process may return one level lower and repeat the pattern matching process for signals within the unit representing the region in order to find a pattern match for those triplets wrongly matched to amino acids.

In a further iteration, further units representing proteins are defined which comprise those units representing the amino acids forming the proteins. Again, beginning and end of these units are marked by tags and an indicator is added marking the unit as corresponding to a protein. Likewise, other known organizational entities are identified and the corresponding data and lower order units are tagged to define a corresponding higher order unit, given the case together with additional information on the organizational entity thus identified. For example, functional relations discovered in research, e.g. the relation of certain domains to diseases, can be embodied by defining a related unit with corresponding tags and corresponding information.

The invention is not limited to text data or genetic data, but can be applied to other data, e.g. a signal representing measurement data, such as spectra, shown in FIG. 4, which follow a function embodying certain information. Suitably one will digitize such signals 102 and then insert tags identifying parts of the signal having a certain meaning or function. For example, parts of a measurement curve to be assigned to a unit may be maxima or minima, e.g. defined by their half-widths, the region between two zeros, sections fitted to predetermined functions or defined by a filter function or the like. Higher order units may, for example, identify individual functions that are superimposed in the measurement data, e.g. spectral contributions from different atoms or molecules. For example, if it is known that the Praseodymium element provides characteristic peaks A, B, C in a spectrum at certain positions corresponding to certain electronic transitions 101, in a first iteration the peaks in the spectrum are identified and tagged to form units assigned to these peaks 105 and in a further iteration those peaks characteristic for the element are combined in further units 106 assigned to specific electronic transitions of the related element.

Subsequently an example applying the invention to a gene sequence is given.

This example starts from the following sequence.

aaacgccaat ggtcagattc tcaaaattaa tttgcatatc
gcttgactcc gtacataact acggaagtaa gcttaagcta
tccaaaccaa atttgaaagg acaagcgtat gtctgaacca
caaaagtctg aaccacaaaa cgggcgcggc
gcgctcttcg ccggt

In a first step single elements are tagged.

aaacgccaat ggtcagattc tcaaaattaa tttgcatatc gc
<token>ttgact<token><lemma kat = “Sig”>op35sgn</
lemma> cc gtacataact acggaag
<token>taagct<token><lemma kat = “Sig”>op10sgn</
lemma> taagcta tccaaaccaa
atttgaaagg acaagcgt
<token>atg</token><lemma kat = “AA”>M</lemma>
<token>tct</token><lemma kat = “AA”>S</lemma>
<token>gaa</token><lemma kat = “AA”>E</lemma>
<token>cca</token><lemma kat = “AA”>P</lemma>
<token>caa</token><lemma kat = “AA”>Q</lemma>
<token>aag</token><lemma kat = “AA”>K</lemma>
<token>tct</token><lemma kat = “AA”>S</lemma>
<token>gaa</token><lemma kat = “AA”>E</lemma>
<token>cca</token><lemma kat = “AA”>P</lemma>
<token>caa</token><lemma kat = “AA”>Q</lemma>
<token>aac</token><lemma kat = “AA”>N</lemma>
<token>ggg</token><lemma kat = “AA”>G</lemma>
<token>cgc</token><lemma kat = “AA”>R</lemma>
<token>ggc</token><lemma kat = “AA”>G</lemma>
<token>gcg</token><lemma kat = “AA”>A</lemma>
<token>ctc</token><lemma kat = “AA”>L</lemma>
<token>ttc</token><lemma kat = “AA”>F</lemma>
<token>gcc</token><lemma kat = “AA”>A</lemma>
<token>ggt</token><lemma kat = “AA”>G</lemma>

One will note that the initial part of the sequence was not assigned to a unit, but a sequence of triplets encoding amino acids was identified (kat=“AA”). The relevant units specify the individual amino acids. Furthermore, two partial sequences were identified which represent a sigma factor binding site (kat=“Sig”). Between these partial sequences and the amino acid triplets there are again partial sequences, which were not assigned to a unit at this level.

In a second step, higher order units are identified as follows:

aaacgccaat ggtcagattc tcaaaattaa
tttgcatatc gc
<Operon name = “merTPCAD operon”>
<token>ttgact<token><lemma kat = Sig>op35sgn</
lemma>
cc gtacataact acggaag
<token>taagct<token><lemma kat = Sig>op10sgn</
lemma>
</Operon>
taagcta tccaaaccaa atttgaaagg acaagcgt
<Protein name = “merT” seq =
“MSEPQKSEPQNGRGALFAG”>
<token>atg/<token><lemma kat = “AA”>M</lemma>
<token>tct/<token><lemma kat = “AA”>S</lemma>
<token>gaa/<token><lemma kat = “AA”>E</lemma>
<token>cca/<token><lemma kat = “AA”>P</lemma>
<token>caa/<token><lemma kat = “AA”>Q</lemma>
<token>aag/<token><lemma kat = “AA”>K</lemma>
<token>tct/<token><lemma kat = “AA”>S</lemma>
<token>gaa/<token><lemma kat = “AA”>E</lemma>
<token>cca/<token><lemma kat = “AA”>P</lemma>
<token>caa/<token><lemma kat = “AA”>Q</lemma>
<token>aac/<token><lemma kat = “AA”>N</lemma>
<token>ggg/<token><lemma kat = “AA”>G</lemma>
<token>cgc/<token><lemma kat = “AA”>R</lemma>
<token>ggc/<token><lemma kat = “AA”>G</lemma>
<token>gcg/<token><lemma kat = “AA”>A</lemma>
<token>ctc/<token><lemma kat = “AA”>L</lemma>
<token>ttc/<token><lemma kat = “AA”>F</lemma>
<token>gcc/<token><lemma kat = “AA”>A</lemma>
<token>ggt/<token><lemma kat = “AA”>G</lemma>
</Protein>

The first two units (sigma factor binding sites) together with the partial sequence between them form an operon which is in fact the merTPCAD-operon.

Furthermore, the sequence of amino acids is combined in a higher order unit representing a protein, namely the protein merT. For reasons of simplicity only a part of the sequence of amino acids of this protein are shown in this example.

In a third step tagging the mercury transporting protein unit together with the regulatory operon could be performed. This is not done in this example, since downstream from the given protein further units can be found, which are not represented to keep this example simple.

Referring to FIG. 5, in a second example the following gene sequence (102) is given.

tttgcatatcgcttgactccgtacataact
acggaagtaagctatgtctgaaccacaaaa
gtctgaaccacaaaacgggcgcggcgcgct
cttcgccggt

In a first step single elements are tagged (104a).

tttgcatatcgc
<token>ttgact</token><lemma kat = “Sig”>op35sgn</lemma>
ccgtacataactacggaag
<token>taagct</token><lemma kat = “Sig”>op10sgn</lemma>
atgtctgaaccacaaaagtctgaaccacaaaacgggcgcggcgcgctcttcgccggt

One will note that the initial and final parts of the sequence were not assigned to a unit. Two partial sequences were identified which represent a sigma factor binding site (kat=“Sig”). Between these two partial sequences there is a partial sequences which was not assigned to a unit at this level.

In a second step, a sequence of triplets encoding amino acids are identified (kat=“AA”). The relevant units specify the individual amino acids (104b):

tttgcatatc gc<token>ttgact</token><lemma
kat = “Sig”>op35sgn</lemma>ccgtacataact
acggaag<token>taagct</token><lemma kat = “Sig”>op10sgn</lemma>
<token>atg</token><lemma kat = “AA”>M</lemma>
<token>tct</token><lemma kat = “AA”>E</lemma>
<token>gaa</token><lemma kat = “AA”>S</lemma>

In a third step, the sequence of amino acids is combined in a higher order unit representing a protein, namely the protein merT (104c).

tttgcatatcgc
<token>ttgact</token><lemma kat = “Sig”>op35sgn</
lemma>
ccgtacataactacggaag
<token>taagct</token><lemma kat = “Sig”>op10sgn</
lemma>
<Protein name = “merT”
seq = “MSEPQKSEPQNGRGALFAG”><token>atg</
token><lemma
kat = “AA”’M</lemma>
...............
<token>ggt</token><lemma kat = “AA”>G</lemma>
</Protein>

These two examples illustrate, how patterns can be identified and sequential data can be structured in biological and especially genetic applications.

The features disclosed in this specification and the claims may be material for the realization of the invention in its various embodiments, taken in isolation or in various combinations thereof.

Several embodiments of the present invention have been described. Nevertheless, it will be understood that various modifications may be made without departing from the spirit and scope of the invention. Accordingly, other embodiments are within the scope of the following claims.

What is claimed is:

1. A method of searching and identifying a signal comprising:
providing a signal comprising one or more signal units
identifying at least one of said signal units by a predetermined pattern having a first order,
comparing a group of said one or more signal units comprising said at least one signal unit, to one or more predetermined patterns having an order higher than said first order,
if a match is found, modifying said signal by replacing said group of said one or more signal units by a higher order signal unit;
identifying said higher order signal unit by a higher order pattern, wherein said higher order pattern comprises information identifying said group of one or more signal units;
wherein said predetermined patterns are ordered according to a hierarchy, wherein a higher order pattern comprises at least one lower order pattern; and
wherein said signal is selected from a group consisting of data, electronic data, transient signals, digital signals, analogue signals, text that does not obey a natural language grammar, spectra, gene sequences and genetic data.

2. The method according to claim 1, wherein said steps of comparing, matching and modifying are repeated until all said one or more signal units are matched and replaced by higher order signal units.

3. The method according to claim 1, wherein said higher order signal unit comprises information distinguishing it from other signal units.

4. The method according to claim 1 wherein said predetermined patterns are stored in a database.

5. The method according to claim 1 further comprising creating a new signal unit comprising said group of said one or more signal units, wherein said new signal unit is identified by said higher order pattern and comprises information indicating said higher order pattern.

6. The method according to claim 5 further comprising at least partly replacing said one or more signal units by said new signal unit.

7. The method according to claim 5 further comprising modifying said signals such that at least one signal unit can be searched for and extracted.

8. The method according to claim 5 further comprising inserting searchable information in said new signal unit.

9. The method according to claim 1 wherein if no match is found for said group of signal units, selecting a new group of signal units and comparing said new group to said predetermined patterns.

10. The method according to claim 9 further comprising repeating the steps of selecting a new group of signal units and comparing said new group to said predetermined patterns until no further matches to said predetermined patterns are found.

11. The method according to claim 10 wherein the steps of selecting, comparing and modifying are repeated, until no match is found or the higher order signal unit comprises the entire modified signal.

12. The method according to claim 1 further comprising extracting at least one signal unit from said signal.

13. The method of claim 1 further comprising tagging said one or more signal units.

14. An apparatus for searching and identifying a signal wherein said signal comprises one or more signal units comprising:
means for identifying at least one of said signal units with a predetermined pattern having a first order;
means for comparing a group of said one or more signal units, comprising said at least one signal unit, to one or more predetermined patterns having an order higher than said first order,
means for modifying said signal if a match is found, by replacing said group of said one or more signal units by a higher order signal unit, wherein said higher order signal unit is identified by a higher order pattern than said first order and comprises information identifying said group of one or more signal units;
wherein said predetermined patterns are ordered according to a hierarchy wherein a higher order pattern comprises at least one lower order pattern; and
wherein said signal is selected from a group consisting of data, electronic data, transient signals, digital signals, analogue signals, text that does not obey a natural language grammar, spectra, gene sequences and genetic data.

15. A method of searching and identifying a signal comprising:
providing a signal comprising one or more signal units;
identifying at least one of said signal units by a predetermined pattern having a first order;
comparing a group of said one or more signal units comprising said at least one signal unit, to one or more predetermined patterns having an order higher than said first order;
if a match is found, modifying said signal by replacing said group of said one or more signal units by a higher order signal unit;
identifying said higher order signal unit by a higher order pattern, wherein said higher order pattern comprises information identifying said group of one or more signal units;
wherein said predetermined patterns are ordered according to a hierarchy, wherein a higher order pattern comprises at least one lower order pattern; and
wherein said signal comprises text that obeys natural language grammar.
